(19) United States
(12) Patent Application Publication
(10) Pub. No.: US 2006/0030955 A1
(43) Pub. Date: Feb. 9, 2006

(54) Method and apparatus for controlling power through a power cord

(76) Inventor: Jonathan M. Lindsay, Rancho Santa Margarita, CA (US)

Correspondence Address: Jonathan M. Lindsay, 20th Floor, 3 Park Plaza, Irvine, CA, 92614-8505, US

(21) Appl. No.: 10/912,471

(22) Filed: Aug. 4, 2004

(51) Int. Cl. G05B 11/01

(52) U.S. Cl. 700/22

(57) ABSTRACT

Disclosed is a method and apparatus for controlling power through a power cord is disclosed. In one embodiment, the invention comprises a power cord coupled to a power control console. The power control console may be programmed to restrict the flow of power through the power cord for only a specific duration or range of times. In another embodiment, user access to the settings of the power control console are restricted. In order to modify the settings of the power control console, and hence modify the restriction on allowing power to flow through the power cord, an access code or other security means may be required to be entered.

### BACKGROUND OF THE INVENTION

1. Field of the Invention

The present invention relates in general to a method and apparatus for controlling power and more particularly, to a method and apparatus for controlling power through a power cord where power-control access is restricted.

2. Background of the invention

Consumer electronic devices that operate using alternating current (AC) have heretofore been provided with power cords that supply power to the attached device in an unrestricted manner. This is to be expected since there is typically no motivation to limit a consumer's ability to power-on an electronic device.

There are presently two primary means of controlling power to a consumer electronic device. First, the consumer electronic device will typically come equipped with a power switch which toggles in an on/off manner. In this case, the consumer is free to turn the device on and off at will. Second, the power cord may be plugged into a separate timer device which is then, in turn, plugged into an AC outlet. The timer device may then be programmed to allow power to run through it only during a specified period of time. Such timing devices have been used for controlling, for example, lamps while a homeowner is away from their home.

In both of the aforementioned cases, the consumer is provided with unfettered access to control the power that is provided to the consumer electronic device in question. However, there may be occasions in which it is desirable to limit a user's ability to control when power flows to the consumer electronic device. For example, in the case of a video game console, a parent may wish to limit the amount of time their child can play while not having to be in the household or actively monitoring the child's activities. Accordingly, there is a need in the art for a method and apparatus for controlling power through a power cord in a restricted fashion.

### BRIEF SUMMARY OF THE INVENTION

Disclosed and claimed herein are methods and apparatus for restricting power flow through a power cord. In one embodiment, a method includes restricting access to one or more power control settings, receiving a valid authorization to access the one or more power control settings, and restricting flow of power through the power cord based on the one or more power control settings.

Other embodiments are disclosed and claimed herein.

### BRIEF DESCRIPTION OF THE DRAWINGS

FIG. 1 is one embodiment of a power cord and power console module consistent with the principles of the invention;

FIG. 2 is one embodiment of the power control module of FIG. 1;

FIG. 3 is a flow diagram of a process for programming the power control module of FIG. 2, according to one embodiment; and

FIG. 4 is a flow diagram of one embodiment of a process for operating the power control module of FIG. 2, consistent with the principles of the invention.

### DETAILED DESCRIPTION OF EXEMPLARY EMBODIMENTS

One aspect of the invention is to provide a power cord to which a power control console has been coupled. It should be appreciated that the power control console may be coupled to the power cord in any number of ways, so long as the power control console is able to i) detect when current is running through the power cord, and ii) prevent the flow of current through the power cord in accordance with the power control settings entered by a user. In one embodiment, a user is able to provide the power control settings to the power control console using an input device, such as a series of buttons, switches, dials, etc.

Another aspect of the invention is to restrict user access to the settings of the power control console. For example, the input device may be further equipped with a keypad into which a PIN must be entered in order to modify the power control settings. While numerous other means of restricting access to the power control module may similarly be used, the following disclosure assumes a keypad is used for restricting user access.

In one embodiment, the power control module is usable to set a length of time (e.g., 1 hour, 2 hours, etc.) and/or a range of time (e.g., 12:00-1:30) during which power will not be restricted from passing through the power cord. Once set, these power control settings may not be changed unless a valid PIN is first entered. Subsequently supplying a valid PIN will ‘unlock’ the power control module and allow the power control settings to be modified, according to one embodiment.

One application in which the invention may be used is in combination with video game consoles. Presently video game consoles are supplied with traditional power cords that plug into the console to supply power thereto. Once plugged in and the power turned on, there is presently no way to restrict the amount of time that power is allowed to flow to the console without actively monitoring the console. This may be undesirable for a parent seeking to limit the amount of time their child engages in game playing on the video game console, while not having to be in the household or actively monitoring the child's activities. Moreover, using a traditional timer device would not be sufficient in restricting the amount of time the child plays with the video game console since the child would be able to freely reprogram the power control console.

Thus, as will be described in more detail below, by replacing the video game console's power cord with a power cord consistent with the invention, a parent will be able to limit the amount of time their child is able to play with the video game console by programming in power control settings to the attached power control console, and then restricting access thereto using a security means (e.g., PIN entered via a keypad).

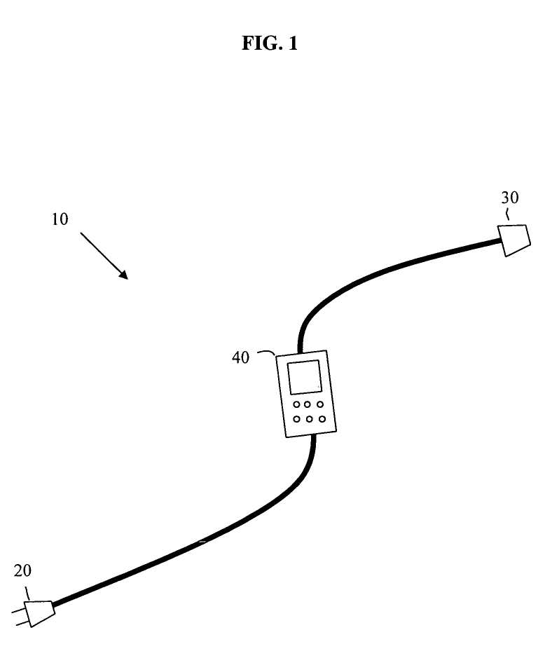

Referring now to the figures, FIG. 1 illustrates one embodiment of a power cord 10 consistent with the principles of the invention. In this embodiment, power cord 10 comprises a wall plug 20, a device plug 30 and a power control console 40. Wall plug 20 may be used to connect the power cord 10 to an AC electrical outlet of any voltage rating, while device plug 30 may be adapted to connect the power cord 10 to any consumer electronic device, such as an appliance, a game console and the like. While FIG. 1 depicts the power control console 40 as being approximately halfway between the wall plug 20 and the device plug 30, it should equally be appreciated that the power control console 40 may be located at any point along power cord 10.

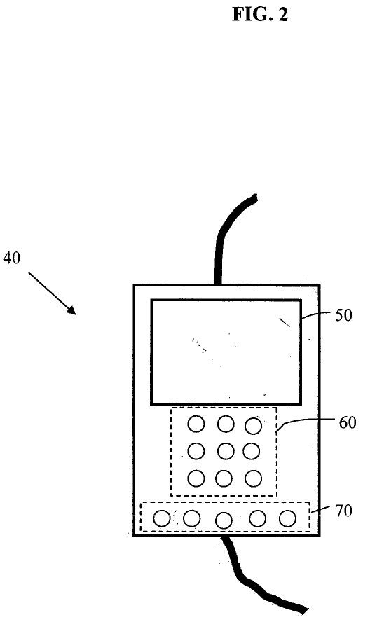

Referring now to FIG. 2, a closer view of one embodiment of power control console 40 is depicted. In this embodiment, power control console 40 comprises a display portion 50, an access control portion 60 and a user functionality portion 70. In one embodiment, a user may specifying a length of time (e.g., 1 hour, 2 hours, etc.) and/or a range of time (e.g., 12:00-1:30) during which power will not be restricted from passing through the power cord. This is may be inputted using user functionality portion 70, or any other known input means. In another embodiment, or in addition to one or more of the previous embodiments, the display portion 50 includes a liquid crystal display (LCD) screen and an input device (e.g., user functionality portion 70) includes a plurality of buttons usable to set the length of time and/or range of time. However, it should equally be appreciated that numerous other forms of display and input device may equally be used and still be consistent with the principles of the invention.

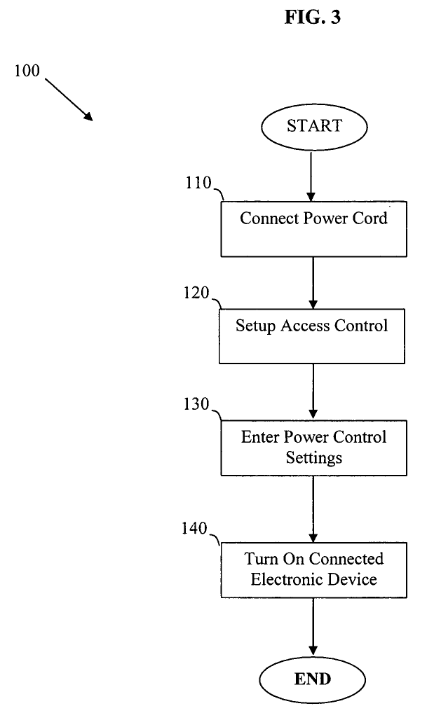

Referring now to FIG. 3, depicted is one embodiment of a process 100 for programming a power control module consistent with the principles of the invention, such as power control console 40. In this embodiment, the power cord 10 is connected at block 110, which in one embodiment includes connecting the cord 10 to a power source, as well as a consumer electronic device. It should further be appreciated, however, that the power cord 10 need not be connected before carrying out the programming operations discussed below.

At block 120, the access control for the console 40 may be setup. In one embodiment, this comprises programming the console after entering an access code usable to modify one or more power control settings (discussed below). While in one embodiment, the access code may be entered using access control portion 60, it should equally be appreciated that any other input means may be used. It should further be appreciated that, instead or in addition to an access code, the access control of the power control console 40 may involve any other known means for restricting access, such as voice verification, biometrics and/or password protection. In the case of a video game console, a parent may use a secret access code to modify or reset the power control settings, which will now be discussed.

Continuing to refer to FIG. 3, process 100 continues to block 130 where one or more power control settings may be entered. While in one embodiment, the power control settings are entered using the user functionality portion 70, other input means may similarly be used. The power control setting, in one embodiment, may include a length of time (e.g., 1 hour, 2 hours, etc.) and/or a range of time (e.g., 12:00-1:30) during which power will not be restricted from passing through the power cord.

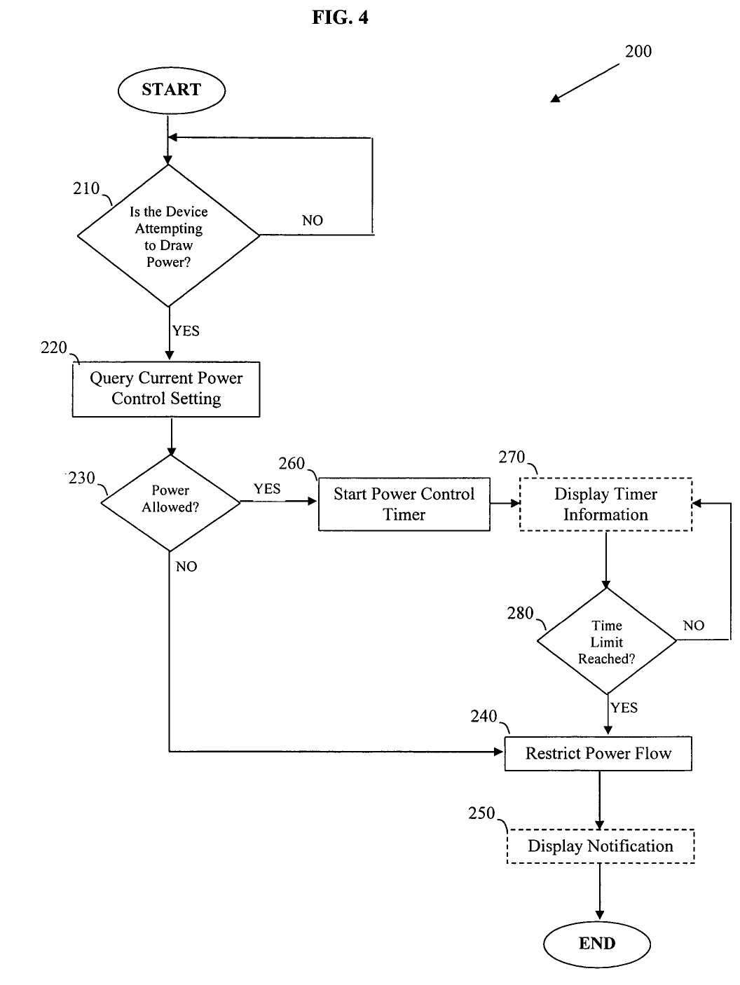

Once the access control has been setup (block 120), the power control settings entered (block 130), the power cord connected (block 110), the connected consumer electronic device may be powered on at block 140. As will be detailed below with reference to FIG. 4, power may or may not be allowed to flow to the connected electronics device depending on the power control settings.

FIG. 4 depicts on embodiment of a process 200 for operating the power cord 10 in general, and the power control console 40 in particular. Process 200 begins with a determination at block 210 as to whether the connected device is attempting to draw power through the power cord 10. If so, process 200 will continue to block 220 where a query will be performed to determine the current power control settings. Based on the current power control settings, a determination can then be made at block 230 as to whether electricity should be allowed to flow through the power control console 40, and hence through the power cord 10 in order to power the connected electronic device. If the power control settings indicate that power is not permitted to flow to the connected device, then process 200 will continue to block 240—power will be restricted and the user may optionally be provided with a notification to that effect (block 250). In one embodiment, the display portion 50 may be used to display a notification to the user that power is being restricted because of the current power control settings.

If, on other hand, it's determined at block 230 that power is allowed to flow (e.g., according to the current power control settings), then process 200 will continue to block 260 where a power control timer may be started. This would be the case, for example, where the power control setting are in terms of a total period of time (e.g., 1 hour, 2 hours, etc.) for which power will not be restricted. Alternatively, where the power control settings are in terms of a range of time (e.g., 12:00-1:00), there would be no need to start a timer. Rather, an internal clock may be used to determine if the range-of-time criteria for allowing power is satisfied. Optionally, timer/time information may be displayed to the user at block 270 (e.g., using display portion 50).

Continuing to refer to FIG. 4, process 200 may then proceed to decision block 280 where a determination is made as to whether the time limit for allowing power has been reached. In one embodiment, the time limit is the end point of a range of time (e.g., 12:00-1:00) entered as part of the power control settings. In another embodiment, the time limit is the end point of a period of time (e.g., 1 hour, 2 hours, etc.). In any event, if the time limit has not been reached, then process 200 will return to block 270 where updated timer information may be displayed to the user. If, on the other hand, a determination is made at block 280 that the time limit has been reached, then process 200 will continue to block 240 where the power flow will be restricted and electricity will not be permitted to flow to the connected electronics device.

It should further be appreciated that, in addition to the timer information of block 270, other information may also be displayed to the user using display portion 50. For example, at some predetermined period of time before the time limit of block 280 is reached, the user may be notified that power to the connected electronic device is about to be stopped. Similarly, an audible notification (e.g., alarm) may also be used to inform the user that the device will soon be turned off by virtue of not having any power flowing to it. In the case of a video game console, this would enable the user to save the current game being played before the gaming console is powered down.

In another embodiment, the power control console 40 may be programmed for multiple users. In this case, each user may be assigned an access code or PIN. This code would be in addition to the main code needed to access and modify the console's 40 power control settings Upon entering the individual user's access code, the console 40 may then access and apply a previously-programmed set of power control settings for that specific user. In this fashion, power restriction settings can be tailored to individual users. In the case of a video game console, a parent may program the power control console 40 to be used by two or more children which are to be granted different power access rights. For example, it may be desirable to grant one child additional power access time as a reward. This would be possible by assigning that child a separate PIN and, as part of the previously described process 100 of FIG. 3., programming the power control console 40 to allow power to flow for an additional amount of time when the proper PIN is supplied.

In sum, in the case of a video game console, replacing the power cord that comes with the game console with power cord 10, will enable a parent to limit the amount of time a child will be able to play the video game console, even when the parent is not able to actively monitor the child. When power cord 10 is adapted to connect to the video game console in question, the manufacturers power cord may be thrown away or otherwise removed from use. At that point, the only means by which the child will be able to operate the video game console is with the properly adapted power cord 10. And once the parent adjusts the power control settings of the console 40 to limit the duration that power will be permitted to flow to the video game console, the parent can rest easy knowing that the child is unable to play the video game console more than the maximum amount of time set by the patent.

It should further be appreciated that the power control console may restrict the flow of electricity through the power cord 10 using numerous known means, the details of which are beyond the scope of the present disclosure. In fact, any means for opening the circuit or otherwise preventing the flow of electricity through a power cord may be used.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A power control module coupled to a power cord, the power control module comprising:
a display portion;
an input portion;
a processor coupled to the display portion and the input portion; and
a memory coupled to the processor, said memory to include one or more instructions to cause the processor to:
restrict access to one or more power control settings until a valid authorization is received,
allow access to said one or more power control settings in response to receiving said valid authorization, and
restrict flow of power through the power cord based on said one or more power control settings.

2. The power control module of claim 1, wherein a first end of said power cord is adapted to connect to a consumer electronic device, and a second end is adapted to connect to a power source.

3. The power control module of claim 1, wherein said display portion is to provide a user notification representative of said one or more power control settings.

4. The power control module of claim 1, wherein said one or more power control settings includes at least one of a duration where power will permitted to flow through said power cord, and a time range during which power will permitted to flow through said power cord.

5. The power control module of claim 1, wherein said valid authorization includes at least one of an access code, a password, a PIN, voice verification and biometrics validation.

6. The power control module of claim 1, wherein said memory further includes one or more instructions to cause the processor to, in response to having said one or more power control settings modified, modify how power will be restricted from flowing through said power cord.

7. A method of restricting power flow through a power cord comprising:
restricting access to one or more power control settings;
receiving a valid authorization to access said one or more power control settings; and
restricting flow of power through said power cord based on said one or more power control settings.

8. The method of claim 7, wherein a first end of said power cord is adapted to connect to a consumer electronic device, and a second end is adapted to connect to a power source.

9. The method of claim 7, further comprising displaying a user notification representative of said one or more power control settings.

10. The method of claim 7, wherein said one or more power control settings includes at least one of a duration where power will permitted to flow through said power cord, and a time range during which power will permitted to flow through said power cord.

11. The method of claim 7, wherein receiving a valid authorization comprises receiving a valid authorization to access said one or more power control settings, where said valid authorization includes at least one of an access code, a password, a PIN, voice verification and biometrics validation.

12. The method of claim 7, further comprising:
modifying, after receiving said valid authorization, said one or more power control settings in response to a request to modify said one or more power control settings; and
modifying said restricting flow of power in accordance with an updated power control setting.

13. An apparatus comprising:
a power cord; and
a power control module coupled to said power cord, said power control module to restrict flow of power through said power cord based on one or more power control settings, wherein said one or more power control settings are modifiable only by providing an access code to said power control module.

14. The apparatus of claim 13, wherein a first end of said power cord is adapted to connect to a consumer electronic device, and a second end is adapted to connect to a power source.

15. The apparatus of claim 13, wherein said power control module further includes a display portion to provide a user notification representative of said one or more power control settings.

16. The apparatus of claim 13, wherein said one or more power control settings includes at least one of a duration where power will permitted to flow through said power cord, and a time range during which power will permitted to flow through said power cord.

17. The apparatus of claim 13, wherein, in response to having said one or more power control settings modified, said power control module modifies how power will be restricted from flowing through said power cord.

18. The apparatus of claim 13, wherein said power control module is further to provide a notification to a user at a predetermined amount of time prior to restricting flow of power through said power cord.

19. The apparatus of claim 13, wherein, after being provided with said access code, said power control module is to be programmed with a plurality of user PINs, wherein each of said plurality of user PINs are associated with a corresponding user power control setting.

20. The apparatus of claim 19, wherein said power control module, in response to receiving one of said plurality of user PINs, is to restrict flow of power through said power cord based on said corresponding user power control setting.
